(19) United States
(12) Patent Application Publication
(10) Pub. No.: US 2013/0015265 A1
(43) Pub. Date: Jan. 17, 2013

(54) VEHICLE AIR FRESHENER HAVING A PRAYER AND SOUND MESSAGE PLAYER

(71) Applicant: Marck Shuval, Barcelona (ES)

(72) Inventor: Marck Shuval, Barcelona (ES)

(21) Appl. No.: 13/635,482

(22) PCT Filed: Mar. 25, 2010
(86) PCT No.: PCT/ES2010/000120

§ 371 Date: Sep. 17, 2012

(51) Int. Cl. A62C 31/28

(52) U.S. Cl. 239/274

(57) ABSTRACT

An air freshener includes a hollow casing having a rear fastener and a lower slot for attachment to a reservoir equipped with a wick for dispersing air freshener through the front holes of said casing. An electronic sound device is equipped with a speaker, batteries for power and an activation means for activating the electronic sound device and playing religious prayers, athletic club songs, national anthems, music tunes or any type of prerecorded sound recording.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC

Not applicable.

### BACKGROUND OF THE INVENTION

1. Field of the Invention

The invention refers to an air freshener for vehicles, with a player for prayers and sound messages, and more specifically, to an air freshener of the type which is set on the ventilation slot of the dashboard in order to spread the scent contained, in a reservoir, and which, moreover permits to play sound messages.

2. Description of Related Art Including Information Disclosed Under 37 CFR 1.97 and 37 CFR 1.98.

Currently, it is common that vehicle users include several items to customize them, and among them, air fresheners which release a scent in order to avoid foul smells are quite usual.

So, a common air freshener comprises a hollow casing having a rear fastener to a ventilation slot of the vehicle dashboard. The casing comprises a lower slot for attachment to a reservoir equipped with a wick for dispersing the air freshener contained inside the casing. The air freshener is dispersed through the from holes of said casing, due to the effect of the air flowing from the ventilation slot, which goes across the rear holes of said casing to the front holes when the ventilation system is operating.

It is also quite common that the user sets other objects his/her taste, such as stickers, badges, hanging elements and others, which sometimes prevents their design not to fit among them.

### BRIEF SUMMARY OF THE INVENTION

The air freshener for vehicles, with at player of prayers and sound messages, which is the object of this invention, features some technical particularities which are intended to provide a complementary use.

The air freshener for vehicles comprises a hollow casing having a rear fastener and a lower slot for attachment to a ventilation slot of a vehicle, and said casing comprises a lower slot for attachment to a reservoir equipped with a wick for dispersing the air freshener contained inside the casing. The air freshener is dispersed through the front holes of said casing, due to the effect of the air flowing from de ventilation slot, which goes across the rear holes of said casing to the front holes.

According to the invention, the air freshener for vehicles comprises an electronic sound device equipped with a speaker, and said casing holds electric batteries for power and an activation means for its activation by the user, for playing religious players, athletic club sounds, national anthems, music runes or any type of pre-recorded sound previously recorded in the digital memory of said electronic sound device.

This permits that, when the user enters the car and starts it, he/she can get a pleasant ambience by the effect of the scent of the air freshener, and moreover, the playing of the prayer which relaxes his/her spirit and motivates it for a safe and responsible driving. This prayer can be recorded in several languages and according to the religion of the user.

In a preferred embodiment, the activation means consist on a pusher on the top casing, but in an alternative one, these activation means can be connected through a wire to the electronic devices of vehicles, for instance the starting key, in order to automatically start the playing of the message when the user enters the vehicle and starts the engine.

The air freshener for vehicles permits that a single object comprises two functions, such as Dispersing the air freshener in the compartment, while allowing to customize the vehicle with the playing of sounds chosen by the user.

The casing consists of two half-casings which can be pressed to fit between them by means of some tabs, and the front casing holds the supports of the electronic device, which consist on a pusher and a box for electric batteries, which are button-type.

This setup allows easy and cheap construction of the air freshener, while providing an inside room big enough to hold the wick of the lower reservoir.

The speaker of the electronic sound device faces part of the rear ventilation holes for the diffusion of sound outwards. The remaining holes not occupied by said speaker are used to release the air freshener carried by the air flow of the ventilation slot.

### BRIEF DESCRIPTION OF THE DRAWINGS

In order to complement the description being made, and with the aim of achieving an easier understanding of the features of the invention, these specifications are complemented with a set of drawings where, for illustrative purposes, and without limitation, the following issues have been represented.

FIG. 1 shows an elevation view of the air freshener, with the reservoir separated from the casing.

FIG. 2 shows a rear view of the air freshener, with the reservoir coupled to the casing.

FIG. 3 shows a side view of the two half-casings separated.

FIG. 4 shows a rear view of the front half-casing, showing the electronic sound device, the pusher and the electric batteries.

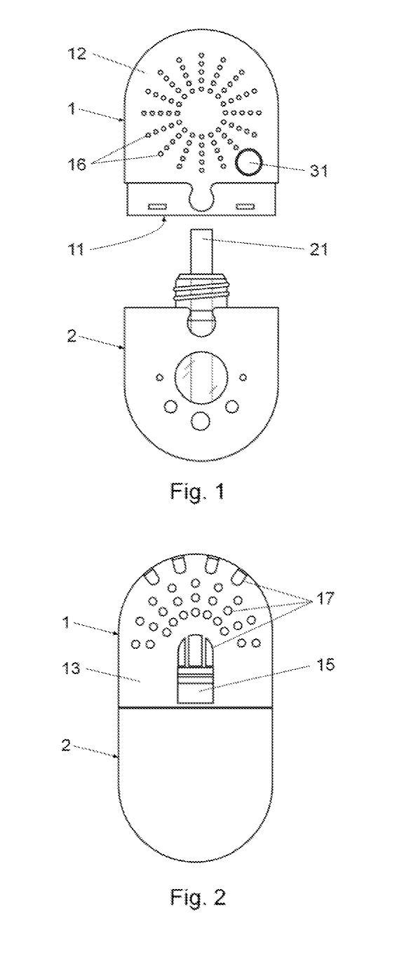

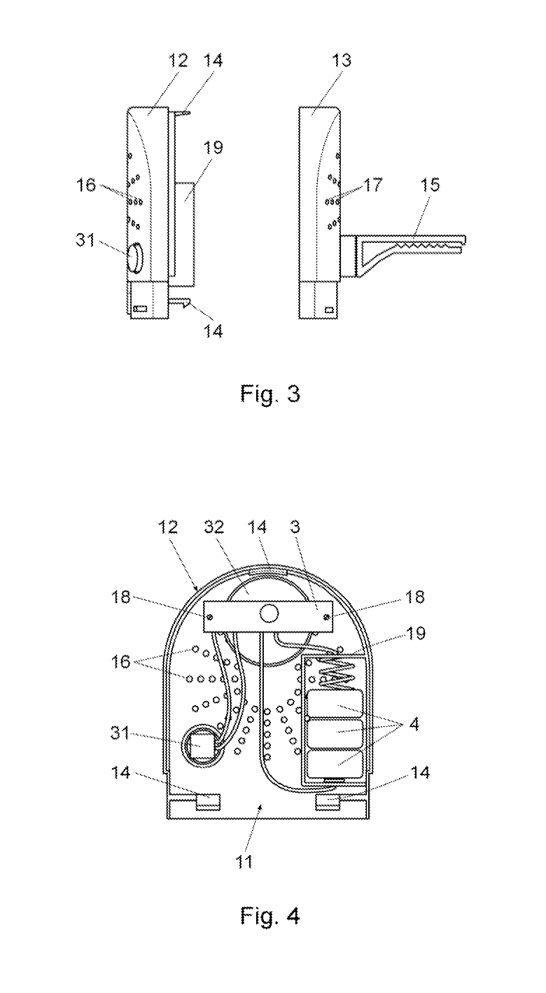

### DETAILED DESCRIPTION OF THE INVENTION

### Preferred Embodiment of the Invention

As shown in the referred figures, the air freshener for vehicles comprises a top hollow casing (1) with a lower slot (11) to which a reservoir is coupled a reservoir (2) containing air freshener, which in this case consists on an inside flask and an outside capsule, and this reservoir (2) features a top wick (21) which disperses the air freshener scent inside the casing (1). The casing (1) consists of two half casings (12, 13) with are pressed into place by means of two fastening tabs (14).

This casing (1) features a rear fastener (15) which is fastened to the ventilation slot (not shown) of the vehicle, front holes (16) and rear holes (17) for the passing of the air released by this ventilation slot.

The front half casing (12) holds an electronic sound device (3), with a digital memory where a prayer or a sound message is recorded, connected to power batteries (4) and which can be activated through operation means, in this case a pusher (31). The electronic sound device (3) is set on a support (18) with screws, and connected to a speaker (32), which faces some of the rear holes (16) for the release of sound playing. The casing (1) holds a box (19) to hold the electric batteries (4), which defines hollow between them to hold the wick (21) of the reservoir (2).

Once the nature of the invention has been described, together with a preferred embodiment of the invention, it is stated for the record that the materials, shape, size and disposition of the described elements may be modified, as long as it does not imply an alteration of the essential features of the invention which are claimed below.

1. An air freshener for vehicles, with a player for prayers and sound messages, of the type which comprises a hollow casing having a rear fastener to be fastened to a ventilation slot of the dashboard of a vehicle, and said casing features a lower slot for attachment to a reservoir equipped with a wick for dispersing air freshener to the inside of the casing, and which is dispersed through the front holes of said casing, through the air flow of the ventilation slot, which goes across the rear holes of said casing to the front holes, and comprising an electronic sound device, characterized by the fact that the electronic sound device is held in the casing, and it has a speaker facing some of the front slots for the passing of air for the dispersion of the sound to the outside, and by the fact that the casing comprises two half casings which are pressed into place by means of tabs; the front half casing holds the supports for the electronic sound device, a box for electric batteries for supplying power to the electronic sound device and some operation means from outside the electronic sound device, which allows the user to operate said electronic sound device to play religious prayers, athletic club sounds, national anthems, music tunes or any type of prerecorded sound recording.
